(19) United States
(12) Patent Application Publication
(10) Pub. No.: US 2005/0097021 A1
(43) Pub. Date: May 5, 2005

(54) Object analysis apparatus

(76) Inventors: Martin Behr, Oakville (CA); Jamieson Babjak, Mississauga (CA); Thomas John Steinhoff, Burlington (CA)

Correspondence Address: OGILVY RENAULT, 1981 MCGILL COLLEGE AVENUE, SUITE 1600, MONTREAL, QC, H3A2Y3, CA

(21) Appl. No.: 10/698,365

(22) Filed: Nov. 3, 2003

(51) Int. Cl. G06F 17/60; G05B 13/02

(52) U.S. Cl. 705/36; 700/28; 705/1

(57) ABSTRACT

The present invention relates to an apparatus, which can be made portable, for presenting batch samples of flowable objects for image capturing, more particularly to an automated apparatus that allows for the image analysis of grain or seeds. Objects are deposited into the hopper of the apparatus and, in a continuous stream, are received from the metered bottom opening of the hopper onto a metering belt, the surface of which is textured so as to frictionally-engage the objects. Objects are thereafter deposited, in a high density monolayer, into discrete object presentation areas on an imaging conveyor. The mechanics of the apparatus are co-ordinated to allow for the simultaneous triggering of a radiation device and an image capturing means only at the instant when the object presentation area arrives at a particular location on the imaging conveyor. Image data is captured with respect to every discrete object within an object presentation area, and is analysed by a computer. The speed of operation of the apparatus, in combination with the computer analysis of the image data, allows for the provision of a rapid quality assessment of a large number of objects and batch samples.

### FIELD OF THE INVENTION

This invention relates to an apparatus for analyzing batch samples of flowable objects.

### RELATED APPLICATION

In Applicant's co-pending Canadian Patent Application Serial 2,390,056 filed Jun. 7, 2002, entitled METHOD AND SYSTEM FOR MANAGING COMMODITY INFORMATION by Rejean Boyer, Rod Perry and Ward Metzler, the disclosure of which is hereby incorporated by reference, there is disclosed a computerized method and system for managing commodity data for a chain of production in which one or more commodities are used in one or more production steps. Commodity data for a particular quantity of a commodity are generated by commodity analysis systems at points in the supply chain and provided to a central data storage system. The commodity data may be traced as the particular quantities of the commodity flow through the chain of production. The commodity data preferably includes commodity characteristics defined in accordance with commodity standards such as specialty trait tracking programs, identity preservation programs and food safety programs in the agri-food industries.

### BACKGROUND OF THE INVENTION

In many supply chains of production, a commodity is sourced from at least one entity, processed in one or more steps and, typically, is transferred or flows between one or more entities in the supply chain. A discrete quantity of a commodity (e.g. a lot or shipment) may be acquired, blended with other lots, refined, transported, or combined with one or more other lots of the other commodities. Increasingly, to meet a variety of producer and consumer interests, there is a need to determine and track commodity characteristics through the supply chain, particularly as a commodity moves between entities in such a chain. This rationale applies to virtually any industry wherein a final product (e.g. the consumable good) is produced from an aggregate of distinct parts or sub-assemblies, or is produced via the homogenization of previously discrete components. The industries affected would include, but are not limited to, the chemical products industries, the electronics and computer manufacturing industries, the food industry (both at the commodity and the end-product production levels), the mineral or gemological industry, and the hardware manufacturing industry.

In the agricultural commodity industries, including animals and crops such as grain, fruit and vegetables as well as other commodities derived therefrom, such as meat, flour, food pellets, etc., the commodities are classified according to certain characteristics. Often, there is a need to determine one or more inherent characteristics of a particular commodity in order to further determine an overall quality characteristic or other standard measure for the commodity. Rudimentary methods for determining commodity characteristics include the visual inspection of the commodity and, typically, a subjective comparison to a defined standard.

By way of example, with agricultural grain and seed commodities (e.g. such as wheat, barley, oats, rye, canola, corn, sunflower, flax, rice, rapeseed, mustard, coffee, and legumes such as soybeans, lentils, chickpeas and other bean species, as well as different species of peas), an overall quality assessment of the grain or seed load that is being sold by the grower (e.g. the farmer) to the grain elevator operator or seed wholesaler/distributor is determined by having available data such as that regarding the size, shape, colour and surface texture of the grain/seed. Having such information available assists in allowing a purchaser to reach a conclusion with respect to the varietal categorization, whether the grain/seed has suffered environmental or handling damage, and whether (or to what degree) the grain/seed load is contaminated with diseased grain/seed. Possession of such information also allows for extrapolations to be made with respect to the degree of grain end-use quality. For example, by being able to estimate the protein (e.g. alpha-amylase) or endosperm content of individual grains or seeds. From a monetary standpoint, the resulting grain/seed quality specifications assigned to the particular load is determinative of the price that is paid to the supplier (e.g. the farmer).

Presently, the inspection of grain or seeds is largely performed on a manual basis. Seed grain suppliers (e.g. grain farmers) arrive at local or regional grain terminal with bulk grain loads and during the off-loading process, grain sample aliquots from the load are taken by an inspector (often an employee of the elevator operator) who then visually (i.e. with the naked eye) examines the seed and determines the quality of the seed with reference to known and accepted seed standards. Despite the fact that seed grain inspectors are highly trained individuals, the analysis that is performed remains open to subjectivity. Furthermore, only a very limited number of samples per shipment may be examined by an inspector, and there is no guarantee that every seed within all samples is inspected. Generally, manual inspection requires 5 to 15 minutes per sample, only a very limited number of samples per load can be evaluated, and there is no guarantee that a load is being evenly sampled. With such practices, little if any reliance is placed on the generation of robust and reliable statistical grain or seed quality assessment data for use in determining quality specifications for the given load. As such, the present practices involving grain and seed quality analysis lead to the distinct possibility of an inequitable price being paid to the supplier, and possibly the converse scenario wherein the grain elevator operator or seed wholesaler is paying a premium for a lower grade commodity. Furthermore, the aggregate quality of the grain/seed held by the elevator operator or seed wholesaler will be determined by the assigned specifications given to the loads purchased from the suppliers.

Proper grain and seed quality assessment is important not only from a strictly monetary standpoint, but also from a public health perspective. In particular, knowing if any, or what percentage, of the grain or seed load is contaminated with grain or seed infected by certain pathogenic micro-organisms becomes important as many of these organisms produce compounds that are harmful to human and animal health. For example, in recent years, wheat seed infected by the fungal plant pathogen Fusarium graminearum (Schwabe) (the causal agent of Fusarium head blight) has become a serious problem given that the fungus produces several mycotoxins such as deoxynivalenol and zearalone, which when present in feedstuff feed to non-ruminants have been shown to reduce growth rates and cause reproductive problems, respectively (Turkington et al., 2002). Furthermore, for commercial purposes, seed barley infected with this pathogen is subject to refusal from brewers and malters as the pathogen-infected grain is unusable in the brewing and malting processes since it causes excessive foaming.

Increasingly, a variety of identity preservation, specialty trait tracking and food safety certification programs are being adopted for a variety of commodities. Such programs impose one or more specifications defining standards for commodity characteristics for products used or produced in a supply chain. For example, a program may require the identification of the variety of a particular discrete quantity of a commodity as comprising a non-genetically modified organism (non-GMO). In addition to defining standards for the commodity itself, some programs mandate standards of production for the commodity. Such standards may relate to growing or raising conditions as well as to other production and processing conditions. Many food safety and other certification programs mandate such standards.

In view of the dispersed nature of the production and distribution of agricultural commodities, and, often, the perishable nature of the commodity, it is generally impractical to conduct analyses using only one instrument. As noted, grain requires analysis at several locations over a wide geographic area in a relatively short time frame (e.g. from the time of immediate post-harvest deposition at a local grain elevator to the time of loading on a bulk freighter for overseas transport). Therefore, commodity analysis systems are usually distributed widely and may be positioned throughout the supply chain in various locations. In some cases, more than one commodity analysis system may exist at a single test location, thereby maximizing the efficiency of the overall inspection process.

By way of example, proper evaluation of the grain or seed quality is also important not only so that farmers are correctly remunerated, but also for allowing the downstream handlers of the grain or seed, such as the grain elevator operator, the grain shipper, and the end-users a greater degree of assurance that the commodity that they are marketing or purchasing has been assessed a fair value as the equipment that is used in the quality assessment allows for a uniform, precise and accurate assessment both within and between samples of the particular commodity. By way of example, grain shippers could be afforded greater assurances that loads will not be refused at a port of entry due to grain contamination that results from the presence of either diseased grain or due to impermissible varietal mixing (e.g. grain or seed harvested from a plant variety that has been genetically modified to resist insect or pathogen infestation or infection, respectively, or to resist the effects of herbicide treatments, or to produce an anti-biotic or animal hormone). Commodity quality assessments could be provided at the time of shipment loading if an apparatus that could provide a rapid, accurate, uniform and reliable analysis were available at or near the loading station. Portability of the apparatus would be an advantage.

With respect to grain commodities in particular, grain elevator operators often blend (i.e. mix together) quantities from grain shipments received from local (i.e. upstream) producers (e.g. farmers). Grain blending is often performed in a rather conservative manner (i.e. too much of the higher quality grain is added to the blend) in order to reduce the risk of having a blended shipment assessed a lower quality specification by a downstream party. The practice of conservative blending of grain shipments results in income loss to the elevator operator, and it would thus be advantageous to have available a readily useable apparatus that could provide rapid, accurate, uniform and reliable analysis of the grain to be blended so as to avoid the necessity of having to extensively blend grain together from different shipments.

To adhere to the standards, for particular quantities of the commodity used or produced in the supply chain, the required commodity must be analyzed and the characteristics identified. Thereafter, those quantities that meet the standard are segregated from other quantities whose characteristics cannot be assured. Further, as those quantities move through the supply chain, the characteristics are monitored to preserve adherence to the standards.

By way of example, the Canadian Grain Commission (CGC) regulates the quality of all grains in Canada. One aspect of grain analysis in Canada is the determination of the Kernel Visual Distinctiveness (KVD) of wheat varieties. This measure helps to track varieties that have specific and uniform end-use characteristics. The CGC monitors customers' needs and adjusts the CGC grading structure according to market demands. The CGC also offers an inspection service that is used by grain elevator operators and the Canadian Wheat Board (CWB). A CGC grain inspector evaluates samples of a grain shipment visually to determine grain characteristics and compares the characteristics to the CGC standard. Elevator operators purchase wheat from farmers on behalf of the CWB. The elevator operators may blend wheat from several farmers in order to produce an amount of wheat that meets a predefined quality grade level. The price for such grain paid to the farmer by the elevator operator and to the elevator operator is determined, in part, by the grade quality of the grain.

Grain shipments are analyzed numerous times between field and market. For example, grain may be analyzed by the CGC at the farmer's local elevator before it is loaded for transporting and is evaluated again when received at the export terminal. Grain elevator operators risk that the grade quality evaluation may not be the same at the receiving end (e.g. the export terminal) as it was at its origin (e.g. the local elevator). In the case of western Canadian wheat, when the re-evaluation of a grain shipment results in a lowering of the shipment's grade quality level, the elevator operator receives less money than expected from the CWB; however, compensation cannot be sought from the farmer.

Although the CGC's grading system is well defined, it is difficult to implement in terms of achieving as near-complete objectivity of intra- and inter-sample analyses, and therefore allowing for equitable payments to be made to those concerned. This can be attributed to sampling bias and the subjectivity of the visual inspection performed on a manual basis by different inspectors on different days.

Mechanised systems for the visual analysis of commodities, especially grain or seed commodities, are known in the art. For example, U.S. Pat. No. 6,427,128 discloses an apparatus and method for evaluating the quality of granular objects such as grains of rice wherein the rice grains are orientated and transported on grooved, light-transparent imaging discs so as to enable the rice grains to be imaged from both sides of the disc. U.S. Pat. No. 5,917,927 discloses an apparatus for inspecting grains wherein the grains are moved in the direction of an image capture device on a grooved tray that oscillates laterally back and forth under the grain feeder components of a vibratory feeder mechanism. The oscillations orient the grains for image capturing. In particular, the apparatus is utilized for the inspection of rice grains to allow for the determination of whether or not a rice grain is broken, and to determine the broken content of a sample. Other mechanised systems for commodity analysis, such as those available from Foss Tecator AB and marketed under the names GrainCheck™ 2312 and Cervitec 1625, also rely on having grains or seeds orientated on a grooved surface at the time of image capturing. Sample analysis rates are limited to approximately 1,000 seeds per minute, for example, with the Cervitec 1625 apparatus.

There remains the need to provide an apparatus for the presentation of discrete objects for their analysis, the objects being presented to a radiation device and a data capture means. More particularly, there remains a need to provide an apparatus for the analysis of discrete objects, especially grain or seed, with the capability of performing a visual analysis of a large number of discrete objects in a very rapid fashion, while at the same time providing a multiplicity of analyses of the discrete objects based on the captured image data per discrete object. Furthermore, there is a need to provide an apparatus for analyzing discrete objects wherein, due to the mechanics of the apparatus, visual imagery data is captured with respect to a substantial number, and potentially every discrete object, in the sample of objects that is loaded into the apparatus. As well, there is a need to provide an apparatus for the analysis of discrete objects wherein the mechanics of the apparatus are synchronized in such a fashion so as to allow for a continuous flow of discrete objects to be presented to an image capturing device while at the same time allowing for the occurrence of a single image capture event with respect to each discrete object. Also, there is a need to provide an apparatus for the analysis of discrete objects wherein the apparatus is capable of being calibrated between each sample run. Furthermore, there is a need to provide an apparatus wherein the apparatus can be automatically calibrated when different types of objects are analysed for each given sample run. Still further, there is a need to provide a portable apparatus for the analysis of discrete objects. Still further, there is a need to provide an apparatus for the analysis of discrete objects wherein the apparatus can be readily used as part of an in-line commodity handling system.

### SUMMARY OF THE INVENTION

The present invention provides an apparatus for analyzing batch samples of flowable objects comprising:
an object feeder having a metered bottom opening which opens onto a metering belt, the metered bottom opening being adjustable in accordance with the object size;
the metering belt having a textured upper surface to engage frictionally the objects flowing from the feeder;
a conveyor located below and close to the metering belt, the conveyor having at least one object presentation area for containing the objects, and having a triggering device associated therewith for a radiation device and a data capturing means;
wherein when a sample of objects is placed in the object feeder for analysis, the metered bottom opening is adjustable to provide a free flow of objects onto the metering belt and hence onto the conveyor for imaging and wherein the metered bottom opening is coordinated with the speeds of the metering belt and the conveyor such that a monolayer of objects of the sample to be analyzed is arranged in at least one object presentation area and as the area moves towards the radiation device and the data capturing means, the associated triggering device sets off the radiation device and data capturing means to enable the gathering of data for analysis.

In a further embodiment, the present invention provides a method for preparing a batch sample of flowable objects for presentation to a radiation device and a data capturing means, the method comprising the steps of:
(a) obtaining a batch sample of the flowable objects to be analyzed, and
(b) depositing the flowable objects into an object analysis apparatus, the apparatus comprising:
an object feeder having a metered bottom opening which opens onto a metering belt, wherein the metered bottom opening is adjustable in accordance with the object size;
the metering belt having a textured upper surface to engage frictionally the objects flowing from the feeder;
a conveyor located below and close to the metering belt, the conveyor having at least one object presentation area for containing the objects, and having a triggering device associated therewith for a radiation device and a data capturing means;
wherein when a sample of objects is placed in the object feeder for analysis, the metered bottom opening is adjustable to provide a free flow of objects onto the metering belt and hence onto the conveyor for imaging, and wherein the metered bottom opening is coordinated with the speeds of the metering belt and the conveyor such that a monolayer of objects of the sample to be analyzed is arranged in at least one object presentation area and as the area moves towards the radiation device and the data capturing means, the associated triggering device sets off the radiation device and data capturing means to enable the gathering of data for analysis.

### BRIEF DESCRIPTION OF THE DRAWINGS

These and other aspects of the present invention are described by reference to the following figures in which:

FIG. 1 is a perspective view of an apparatus for analyzing objects, the apparatus having its shrouding in place.

FIG. 2 is another perspective view of the apparatus with its shrouding in place.

FIG. 3 is a perspective view of the various components of the object analysis apparatus according to the present invention.

FIG. 4 is a side view of various components of the object analysis apparatus shown in FIG. 3.

FIG. 5 is a partial cross-sectional view of an object feeder and metering belt components of the object analysis apparatus as shown in FIG. 3.

FIG. 6 is a perspective view of an imaging conveyor of the object analysis apparatus shown in FIG. 3.

FIG. 7 is an exploded view of the imaging conveyor belt shown in FIG. 6.

FIG. 8 is a cross-sectional view of the imaging conveyor shown along the section line D-D′ in FIG. 6.

FIG. 9 is a perspective view of the radiation device and the image capturing device of the present invention.

FIG. 10 is a perspective view of a radiation device and a data capturing means of the object analysis apparatus of the present invention.

FIG. 11 is a perspective view of the object feeder and imaging conveyor of the present invention with the colour reference slide housing attached to the imaging conveyor.

FIG. 12A is a perspective view of the reference slide component of the present invention.

FIG. 12B is a top view of the reference slide component shown in FIG. 12A.

FIG. 12C is a cross-sectional view of the reference slide component shown along the section line A-A′ in FIG. 12B.

### DETAILED DESCRIPTION OF A SPECIFIC EMBODIMENT OF THE INVENTION

A specific embodiment of the present invention is explained hereunder with reference to the accompanying drawings.

As used in the present specification, “objects” means flowable, dry solid objects including, but not limited to seeds, grains, polymer pellets, mineral particles, and manufactured hardware. Examples of objects that may be analyzed in this invention include, but are not limited to, those utilized in the manufacture of, or produced from the manufacturing of pharmaceuticals, foodstuffs, electronics, agricultural products and automotive products. Objects to be analyzed in this invention may range in size and shape, but are typically in the size range of about 2 mm for a minimum dimension to about 10 mm for a maximum dimension. If rod shaped, a suitable size range is about 2 mm diameter to about 6 mm long to about 4 mm diameter to about 10 mm long; if spherically shaped, a suitable object size range is of about 2 mm in diameter to about 10 mm in diamter. Batch sample size volumes of the objects to be analyzed may vary, but may be in the range of about 500 mL to about 700 mL. Free flowing clean samples are most easily analyzed in the present invention.

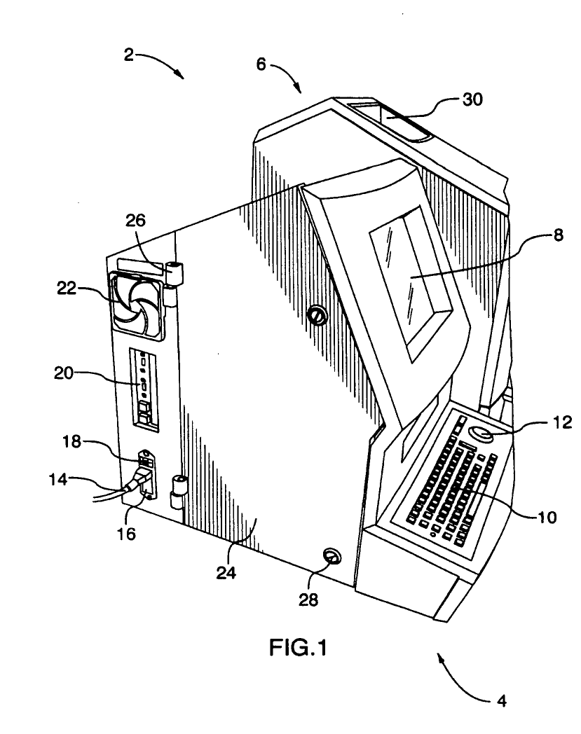

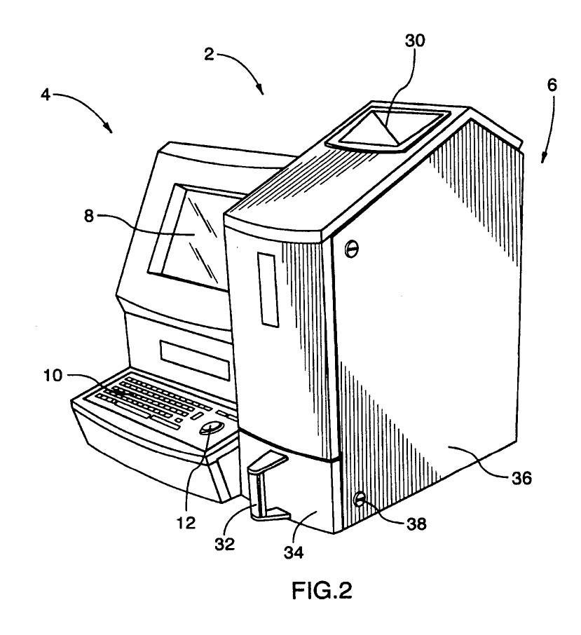

In FIGS. 1 and 2 there is generally shown at 2 an object analysis apparatus of the invention. The apparatus 2 is shown to contain two modules designated generally at 4 and 6. Generally, module 4 contains the apparatus' electronic components utilized for inputting programming instructions into the object analysis apparatus 2, and in the analysis and display of the captured data. Module 4 also contains the apparatus' command control systems for controlling the operation of the mechanical components generally contained in the second module 6 of the apparatus 2.

Referring to FIG. 1, the apparatus 2 contains a first module 4 that bears an interchangeable user interface, such as a display screen 8, and when required, a keyboard 10 with a pointing device such as a roller ball, a joystick, a mouse, a touch screen, a touch pad and a voice-activated device 12. Electrical power is supplied to the apparatus 2 via a power cord 14 connected to a socket 16 in the apparatus 2, the socket 16 being located in proximity to the on/off switch 18 for the apparatus 2. A small panel 20 is located between the on/off switch 18 and an air filter 22, the small panel 20 being provided with a LAN, modem, USB connectors, as well as having a variety of manually-operated switches and fuses for the various electrical and electro-mechanical components of the apparatus 2. The air filter 22 aids in maintaining a substantially dust-free air environment within the module 4. Accessibility to the interior of the module 4 is provided via a side cover panel 24 that is attached to the module 4 by hinges 26. Accessing the interior of the module 4 is accomplished by releasing lock screws 28 that secure the side cover panel 24 in a locked position.

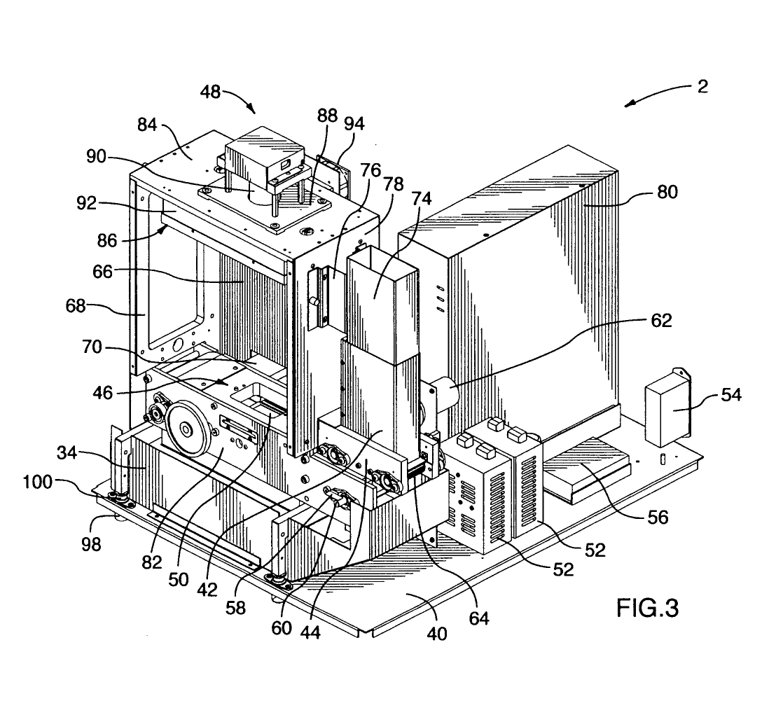

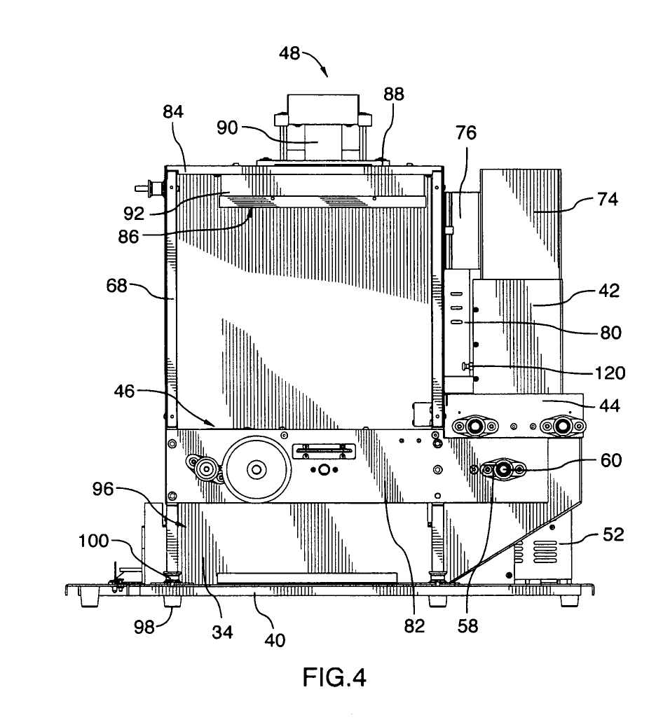

Referring to FIG. 2, the second module 6 of the apparatus 2 is seen to contain an inlet 30 through which objects to be analyzed are deposited into the apparatus 2. Provided at the bottom, front of the module 6 is a handle 32 that is attached to a receptacle 34 (see FIGS. 3 and 4) for receiving objects for which data has been captured. Accessibility to the interior of the module 6 is provided via a side cover panel 36 that is attached to the module 6 by suitable means. Accessing the interior of the module 6 is accomplished by releasing lock screws 38 that secure the side cover panel 36 in a locked position.

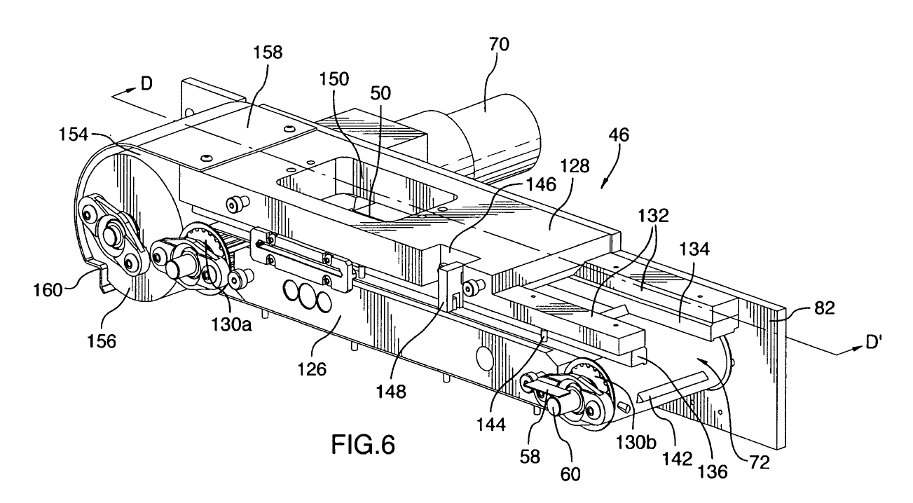

FIG. 3 generally shows at 2 the object analysis apparatus of the invention having its housing cover, display screen and keyboard (not shown) removed. Mounted on a base plate 40 is an object feeder, more particularly a hopper, shown generally at 42, a metering belt housing shown generally at 44, and an imaging conveyor shown generally at 46. Data capturing means, and more particularly an image capturing device shown generally at 48, is mounted above the imaging conveyor 46 directly in-line with an image viewing area opening 50 located in the top of the imaging conveyor 46. A receptacle 34 for receiving objects that have been conveyed past the image viewing area opening 50 is provided below the imaging conveyor 46. Power supply units 52 are located on the base plate 40 together with a power entry module 54 and a power distribution circuitry panel 56. A tab 58 provided on a shaft 60 of the imaging conveyor 46 allows for the apparatus 2 to be electrically grounded, thereby allowing for the dissipation of any static electrical charge that may build up on any component of the apparatus 2. A motor 62, which may be a gear motor, provides positive drive for a metering belt 64 situated within the metering belt housing 44. Attached to the imaging conveyor 46, and situated behind a back plate 66 attached to a set of upright struts 68, is a motor 70, which may be a gear motor. The motor 70 provides a positive drive force for an imaging conveyor belt 72 (not shown in FIG. 3, refer to FIGS. 6 to 8 and 11). Attached to the hopper 42 is a hopper extension 74, the hopper extension 74 being secured by a bracket 76 to an end plate 78 that is attached to the upright struts 68.

A mini-programmable computer (PC) is shown generally at 80 which receives the images captured by the image capturing device 48 for object analysis. While the mini-PC 80 is shown here as part of the object analysis apparatus 2, it may be separate from the apparatus, in which case the image capturing device 48 and hence apparatus 2 would include appropriate connections for a separate computer. The mini-PC 80, power supply units 52, power entry module 54 and power distribution circuitry panel 56 can be separated from the object feeder 42, metering belt housing 44, and the imaging conveyor 46 components of the apparatus 2 by means of a divider plate (not shown), thereby allowing for the formation of the two distinct modules 4 and 6 of the apparatus 2.

FIG. 4 illustrates the object analysis apparatus 2 in side view and offers another view of the arrangement of the components described above and seen in FIG. 3. As is apparent, the components described can all be mounted on base plate 40 in a suitable manner via typical mounting means known to a person skilled in the art. More particularly, secured to the set of upright struts 68 are a set of generally-rectangular plates 82 that cover and are secured to the imaging conveyor 46 along the longitudinal axis of the imaging conveyor 46. The plates 82 also cover and have secured to them the metering belt housing component 44. Associated with and located above the metering belt housing 44 is the hopper 42 for receiving objects to be analyzed. The securing (through suitable known means) of the plates 82 to the struts 68, along with the securing of the imaging conveyor 46 and the metering belt housing 44 to the plates 82, allows for the imaging conveyor 46 and the metering belt housing 44 to remain firmly in place while the object analysis apparatus 2 operates.

Situated above the imaging conveyor 46, and secured to the struts 68 via a generally rectangular-shaped plate 84, are the image capturing device 48 and a radiation device 86, the image capturing device 48 being secured to plate 84 by a secondary, generally rectangular-shaped plate 88. The radiation device 86 and the portion of a lens 90 of the image capturing device 48 situated proximal to the radiation device 86 are maintained in a positive air pressure environment relative to that found in the mechanical component module 6 through a supply of air vented into the sealed cover portion 92 surrounding the radiation device 86 and the lens 90, the air being vented from the module 4 of the apparatus 2. From FIG. 3, it can be seen that air vented into the sealed environment via a connecting portal 94 (FIG. 3) between the two modules 4 and 6, the connecting portal 94 (FIG. 3) having an air filter, similar to the air filter 22 (FIG. 1), situated therein.

The plates 82 are secured to the struts 68 so as to accommodate the receptacle 34 for deposit of the objects that exit off of the imaging conveyor 46 into a collection area 96 after the objects are conveyed past the image viewing area opening 50 (see FIG. 3). The receptacle 34 can be selected from a variety of items, for example the group comprising a bin, a sealable container, a drawer, a conveyor and a weigh scale.

Situated between the lower end of each of the struts 68 and the base plate 40, or raised supports 98, is a vibration dampener 100 that assists in substantially reducing or dampening the effects of extraneous sources of vibration relative to the apparatus 2.

As is apparent from FIGS. 1, 2, 3 and 4, the apparatus 2 may be constructed in a fashion which allows for it to be portable and hence located and re-located as required for use. In such instance, a number of modular units may comprise the apparatus.

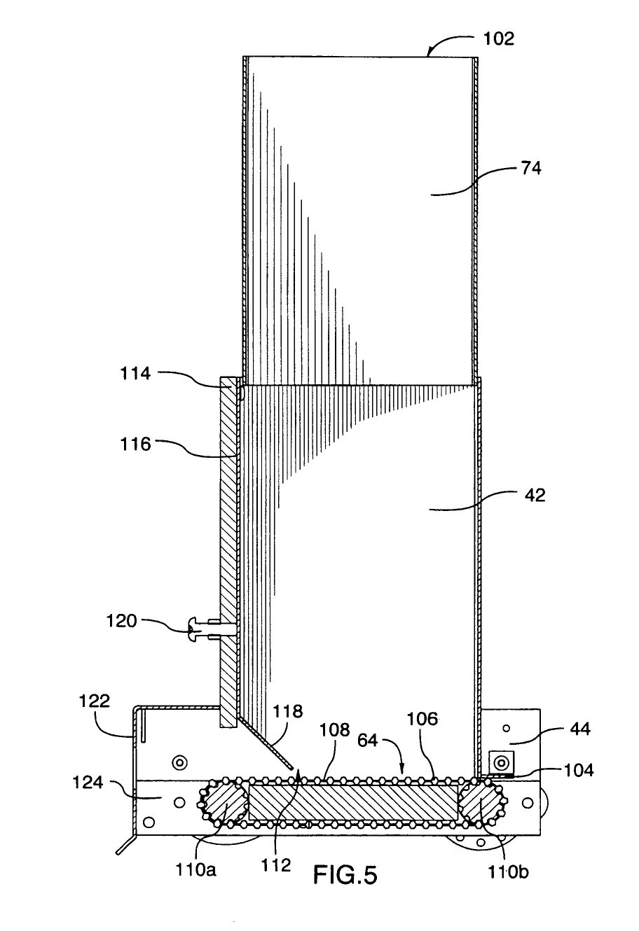

Referring now to FIG. 5, a partial cross-sectional view of the hopper 42, which has the hopper extension 74 attached thereto, is illustrated. As shown, the hopper extension 74 includes a top opening 102 which is located appropriately to the inlet 30 (see FIG. 2) of the apparatus 2, and receives a sample of the objects, usually grain or seeds, for image capturing and analysis. A base flange 104 of the hopper 42 is attached to the metering belt housing 44 so as to ensure that a metered bottom opening 112 of the hopper 42 is in close proximity to the top of metering belt 64, thereby preventing objects from escaping between the hopper 42 and the metering belt 64 and further preventing the wedging of any objects between the base flange 104 of the hopper 42 and the revolving metering belt 64. Effectively, the metering belt 64 functions as the floor of the hopper 42.

The metering belt 64 is shown with a pitch and tooth profile, but other configurations may be used. Objects in contact with the metering belt 64 become frictionally-engaged by teeth 106 on the metering belt 64, resulting in individual objects residing in a cavity 108 between adjacent teeth 106. The object-bearing surface of the metering belt 64 may be configured with grooves that create cavity rows, but alternative surface configurations such as, but not limited to, lattices, cells, turret-shaped projections, pyramid-like projections, finger-like projections and cone-like projections may also be selected. The non-object bearing side of the metering belt 64 passes over toothed pulleys 110a and 110b that engage the metering belt 64. The toothed pulley 110a located at the end of the metering belt 64 where the objects fall off of the metering belt 64 is positively driven by the motor 62 (see FIG. 3).

The configuration of the metered bottom opening 112 of the hopper 42 is such that only one wall 114 allows passage of objects outside of the opening 112. In a specific embodiment of the hopper 42, a metering plate 116 is provided that can be adjustably secured to the wall 114 of the hopper 42 relative to the metering belt 64. Metering plate 116 includes an angled portion 118 that directs the objects so as to create an eddying effect upon the objects within the hopper 42 in the vicinity of the metered bottom opening 112, thereby causing the re-circulation back into the batch sample of objects within the hopper 42 of those objects that are not frictionally-engaged by the teeth 106 on the metering belt 64 at a given instance of time, thus maintaining the free flow of objects from the metered bottom opening 112 of the hopper 42 onto the metering belt 64.

The position of the metering plate 116 can be adjusted relative to the metering belt 64 upon the loosening and re-tightening of the tensioning force provided by a set screw 120. It will be recognised by those of skill in the art that metering plate 116 could be of different design. For example, it could have a hinged angled portion 118, or wall 114 could have a similar hinged portion to the angled portion 118 of the metering plate 116. Attached to the metering belt housing 44 is a guard plate 122 that prevents objects from escaping into other areas of the apparatus 2 as the objects proceed through the object exit area 124 upon leaving the metering belt 64. The metered bottom opening 112 just described is but one configuration that can be used to control the flow of objects from the hopper 42. Other arrangements would be apparent to the person skilled in the art that would allow for the adjustment of the metering plate 116 in the required manner.

As can be seen in FIGS. 6 through 8, the imaging conveyor 46 comprises an imaging conveyor belt 72, a slider bed 126 that has upper and lower surfaces over which the imaging conveyor belt 72 passes, and an imaging conveyor cover 128.

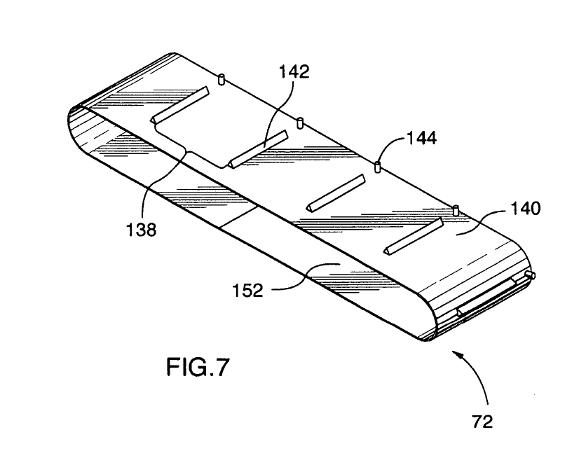

Referring to FIGS. 6 and 7, secured to both ends of the slider bed 126 are toothed pulleys 130a and 130b. Connected to the toothed pulley 130a at the leading edge of the imaging conveyor belt 72 is the gear motor 70 that provides for the positive drive of the toothed pulley 130a and hence the imaging conveyor belt 72.

The imaging conveyor cover 128 of the present example is adapted to allow for metering belt housing 44 (see FIGS. 3, 4 and 11) to rest upon rails 132 projecting from the end of the imaging conveyor cover 128 proximal to the metering belt housing 44. The surface of the imaging conveyor cover 128 proximal to the imaging conveyor belt 72 can be generally white in colour in order to reflect radiation of the visible wavelength spectrum. Provided below the rails 132 and running the length of the imaging conveyor cover 128 are runners 134 and 136, the runners 134 and 136 functioning as containment walls for an object presentation area 138 (see specifically FIG. 7) on an imaging conveyor belt 72. The runners 134 and 136, can be coloured in order to match the colour of the imaging conveyor belt 72, in this case blue, and are integral with the imaging conveyor cover 128. Generally, they are secured to the rails 132. The runners 134 and 136 are of equal height, and together with vertical thickness of the rails 132, define the distance that an object will fall upon dropping off metering belt 64 and traversing through the object exit area 124 of the metering belt housing 44 and onto the imaging conveyor belt 72. The runner 134 abuts the plate 82 proximal to the gear motor 70, and is of a width so as to occupy the area of the imaging surface 140 of the imaging conveyor belt 72 situated between the end of each divider 142 located on the imaging surface 140 and the edge of the imaging conveyor belt 72 proximal to the nearly rectangular plate 82. The runner 136 is of a width so as to occupy the area of the imaging surface 140 of the imaging conveyor belt 72 situated between the end of each divider 142 and a triggering device 144 located on the imaging surface 140 of the imaging conveyor belt 72.

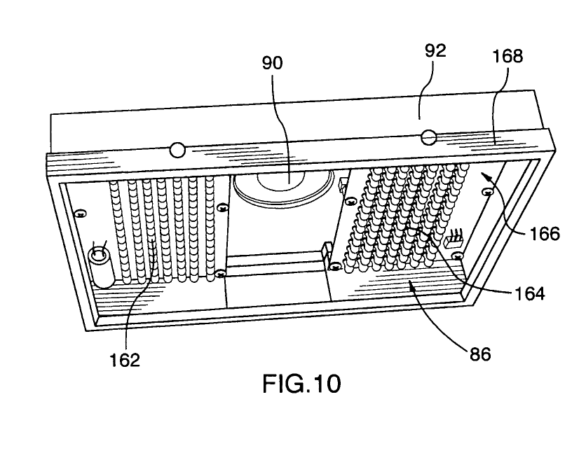

In one embodiment, a notched area 146 is provided in the imaging conveyor cover 128 to accommodate the insertion of a sensor 148 for detecting the presence of the triggering device 144, the detection of which initiates the operation of both the radiation device 86 (see FIG. 10) and the image capturing device 48 (see FIG. 4). In one embodiment of the invention, the sensor 148 is inserted within the imaging conveyor cover 128 so as to align with the edge of the image viewing area opening 50 (located in the imaging conveyor cover 128) most proximal to the metering belt housing 44. It will be recognised, however, that such a sensor 148 can be positioned in a variety of locations so long as the sensor can detect a trigger at the necessary time. While in this example the sensor 148 is of the through beam type, it will recognised that any other suitable sensor may be used, for example a capacitive proximity sensor, an inductive proximity sensor, a reed switch, a mechanical switch and an optical encoder.

The circumference 150 of the image viewing area opening 50 is coated with a material that reflects the radiation emanating from the radiation device 86 (see FIG. 10) back into the object presentation area 138 of the imaging conveyor belt. In the present example, the circumference 150 is coated with a material that reflects radiation in the visible wavelength spectrum, the circumference 150 generally being white in colour, the reflected radiation aiding in alleviating any vignetting that may occur in the object presentation area 138.

Referring more specifically to FIG. 7, provided on the imaging surface 140 of the imaging conveyor belt 72 is a plurality of dividers, in this case cleats 142, the cleats 142 being spaced equidistantly and being of a width that they provide a set of parallel walls for the object presentation areas 138. The cleats 142, together with the runners 134 and 136 (see FIG. 6), define a series of congruent object presentation areas 138 on the imaging surface 140 of the imaging conveyor belt 72. In the present case, each cleat 142 is constructed from polyurethane, although any of a number of durable materials may be used in constructing the cleats 142. The imaging conveyor belt 72 is composed of a non-stretchable base layer 152 and a top coat material that forms the imaging surface 140 of the imaging conveyor belt 72. The base layer 152 may have embedded within it reinforcing cords. While it will be realized that a number of different materials, such as but not limited to flexible wire or plastic, may be used for the reinforcing cords, the present example utilizes Kevlar® for the reinforcing cords. Furthermore, while the base layer 152 can be manufactured from a number of composite materials, urethane is used in this example. Regarding the top coat material that forms the imaging surface 140 of the imaging conveyor belt 72, the top coat material may be a food-grade urethane, although a lower quality urethane may also be employed if the particle analysis apparatus 2 is being used in an environment where the use of a food-grade materials is not mandated. As well, it may be useful for the top coat material to be resistant to the holding of an electrical charge. The material of the imaging conveyor belt 72 is blue polyurethane in this embodiment. This provides a neutral background while achieving a high contrast with the objects being imaged.

Associated with each object presentation area 138 is a triggering device 144 that cooperates with the sensor 148 for both the radiation device 86 and a data capturing means, in this example an image capturing device 48, so as to allow for the simultaneous irradiation of an object presentation area 138 and the capturing of an image of the objects deposited in the object presentation area 138. In the present example, the triggering device 144 is a vertical peg, which is permanently affixed to the imaging surface 140 of the imaging conveyor belt 72. It will be recognized, however, that the triggering device 144 can be selected from any number of devices for example, a hole in the imaging conveyor belt 72, a mechanical switch, a magnet, and an optically distinguishable object associated with the imaging conveyor belt 72. As well, it will be recognized that the triggering device 144 does not necessarily have to be affixed to the imaging surface 140 of the imaging conveyor belt 72, as long as the choice and location of the triggering device 144 is compatible for its cooperation with the sensor 148.

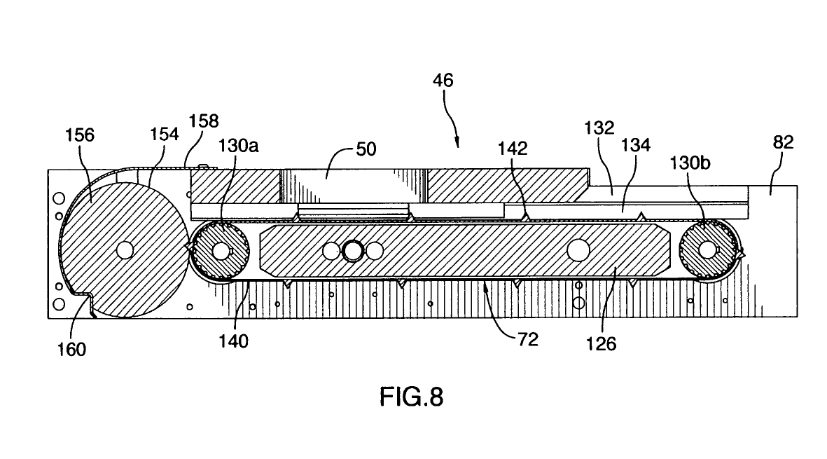

Referring to FIGS. 6 and 8, means to continuously clean the imaging surface 140 of the imaging conveyor belt 72 are also provided in the object analysis apparatus 2. This embodiment includes a brush 154 provided on a roller 156 situated at the end of the imaging conveyor 46 distal to where the objects are deposited on the imaging conveyor 46. It will be recognized that a variety of materials can be used to construct the brush 154. In this embodiment, the brush 154 is composed of a combination of nylon and brass bristles, more specifically of about 85% nylon and of about 15% brass.

The roller 156 is secured to the plates 82 that cover the front and back of the imaging conveyor 46, and is driven by the motor 70. A cover 158 is provided for the brush 154, the cover 158 being attached to the imaging conveyor cover 128 by suitable means. As shown in greater detail in FIG. 8, cover 158 is provided with an indentation 160 that engages the bristles of the brush 154, thereby providing means to dislodge any objects or other material that may become lodged in the bristles of the brush 154. Furthermore, the cover 158 prevents any objects or other material dislodged from the imaging surface 140 of the imaging conveyor belt 72, or dislodged from the bristles of the brush 154, from escaping into other areas of the object analysis apparatus 2, for example, back onto the imaging conveyor belt 72.

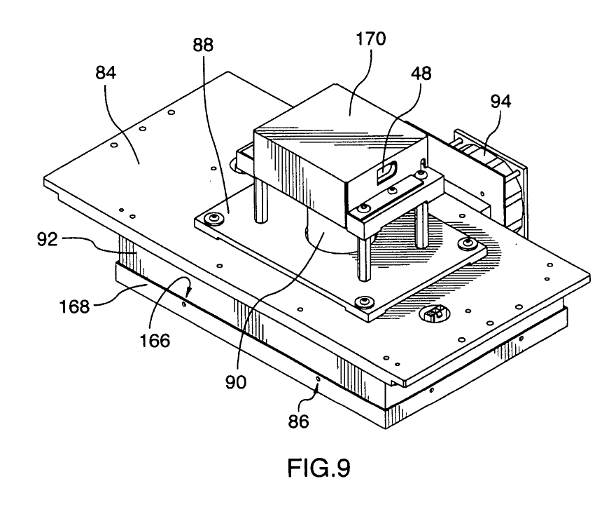

Referring to FIGS. 9 and 10, image data with respect to the objects is captured through the use of an image capturing device 48 that is positioned directly above the image viewing area opening 50 in the imaging conveyor cover 128. The lens 90 of the image capturing device 48 projects past the horizontal plane of the rectangular-shaped plate 84 that is used to secure both the secondary, generally rectangular-shaped plate 88 and the radiation device 86 to the struts 68. In this embodiment, the image capturing device 48 is a digital camera, for example a charged-coupled device (CCD) or digital colour camera, although it will be appreciated that alternative image capturing devices, such as a video camera or any other type of analog camera could be utilized. The advantage of using a digital camera is that access to raw picture element (pixel) data is available and no image data is converted by the imaging device 48. Instead, image data processing occurs in the computing device 80 that is, in the present example, situated within the module 4 for the object analysis apparatus 2. Access to the raw pixel data thereby allows for greater control over data processing.

Referring more specifically to FIG. 10, the radiation device 86 consists of separate spotlights 162 and 164 mounted beside the lens 90 of the image capturing device 48. The spotlights 162 and 164 are set angularly to the plane of the imaging conveyor belt 72. The angle at which the spotlights 162 and 164 are set is determined in part by the reflective surface characteristics of the image viewing area opening 50. In this embodiment, each of the spotlights 162 and 164 is a panel of light emitting diodes (LED's). The number of LED's per panel is determined by the required amount of illumination. It will be appreciated that other types of radiation sources may be substituted for the LED's. Examples of alternative radiation sources include incandescent lights, fluorescent lights, infrared lights, halogen lights, xenon gas and ultraviolet (UV) lights. The spotlights 162 and 164 operate in a strobed fashion in this form of the invention.

In a specific embodiment of the invention, the image capturing device 48 and the radiation device 86 are in a sealed environment that reduces the potential exposure of the image capturing device 48 and the radiation device 86 to any airborne particulate matter that is generated due to the operation of the object analysis apparatus 2, or due to the given air quality conditions at the location or building wherein the object analysis apparatus 2 is maintained. To provide the sealed environment, a glass plate 166 having an anti-reflective coating is secured in place by cover 92 attached to the rectangular shaped plate 84, the glass plate 166 is sealed to the cover 92 by a glass plate retaining ring 168 and weather stripping. Over top of the image capturing device 48 is located a cover 170 (see FIG. 9) with downwardly-extending corner columns that allow for the cover 170 to be secured to the secondary, generally-rectangular plate 88. As previously described, air is supplied to the sealed environment wherein the radiation device 86 and the lens 90 of the image capturing device 48 are located, via a connecting portal 94, and the air must pass through a filter (not shown) located within the portal 94. Air flow sensor means (not shown) are provided to monitor the rate of flow of air into the sealed environment, and when the rate of air flow into the sealed environment falls below a critical value, the operation of the apparatus 2 ceases automatically.

Calibration of the Apparatus

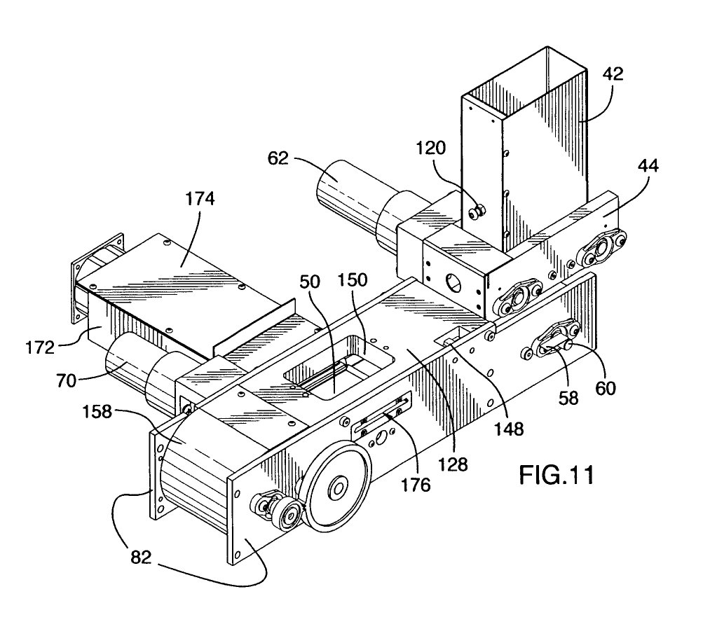

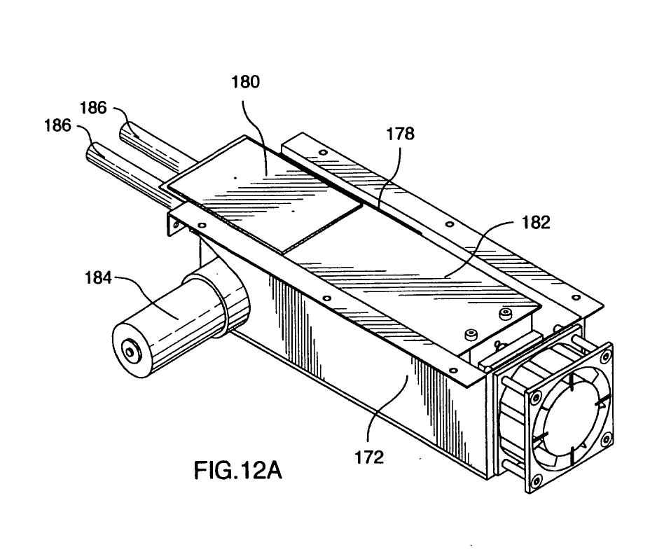

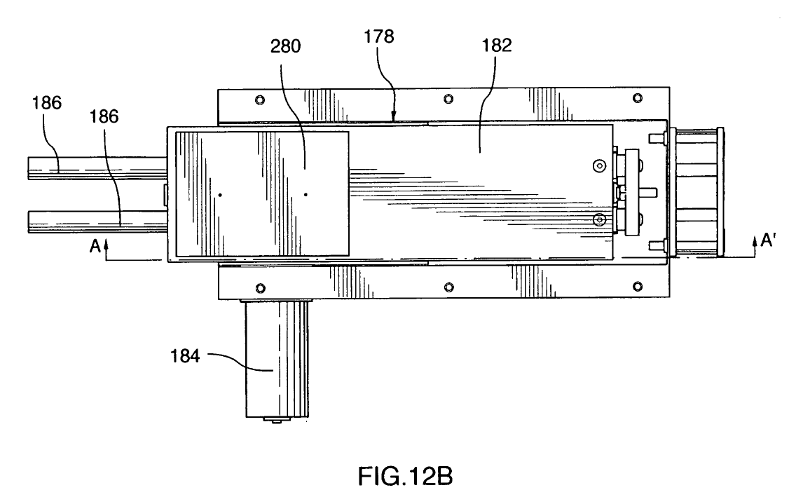

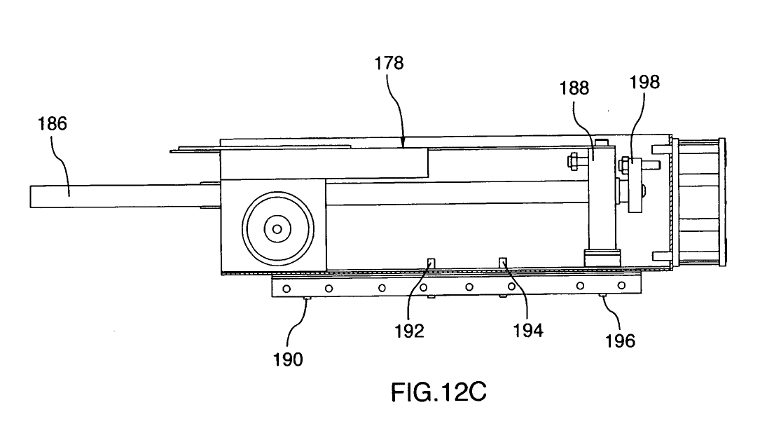

Calibration of the apparatus 2 may be performed prior to each batch sample analysis, or when it is convenient to do so. Referring to FIG. 11, calibration means is provided by attaching a reference slide housing 172 component, shown with its cover 174 in place, to the plate 82 that is secured to the imaging conveyor 46. Securing of the colour reference slide housing 172 to the imaging conveyor 46 occurs adjacent to the image viewing area opening 50 provided in the imaging conveyor cover 128. A slot-like opening 176 is provided on both sides of the imaging conveyor cover 128, the slot-like opening 176 allowing for the insertion and retraction of a reference slide 178 (see FIGS. 12A-12C) into and from the lowermost portion of the image viewing area opening 50.

As shown in FIGS. 12A and 12B, the reference slide 178 is divided into two distinct sections. A section composed of at least one colour chart 180 is located proximal to the point where the reference slide housing 172 attaches to the imaging conveyor 46, while a grey colour section 182 is provided distal to the colour chart 180 section. In the present example, the colour chart section 180 is divided into a plurality of sub-sections, for example, two sub-sections each with twelve different colour squares. Neutral 8 is an example of the grey colour used for the grey colour section 182. A motor 184, in this case a gear motor, is provided with calibration means in order to provide the actuating force to move the reference slide 178. Attached to the end of a shaft (not shown) from the motor 184 is a pinion gear (not shown), the pinion gear being situated between guide rails 186 that extend back into the reference slide housing 172. On securing of the reference slide housing 172 to the imaging conveyor 46, the portions of the guide rails 186 that extend from the reference slide housing 172 become inserted within the imaging conveyor 46 at a point below the image viewing area opening 50 (see FIG. 11).

As shown in FIG. 12C, the reference slide 178 is connected to a vertical member 188, and the vertical member 188 is attached to a rack (not shown) that is located between the two guide rails 186 within the reference slide housing 172. Actuation of the motor 184 causes the pinion gear to move the rack and the attached vertical member 188, thereby concomitantly moving the reference slide 178. A positioning sensor 190 is provided so as to detect when the reference slide 178 is fully extended, while positioning sensors 192 and 194 detect when the reference slide 178 is extended an intermediate length. Positioning sensor 196 is provided to detect when the reference slide 178 is fully retracted into the reference slide housing 172. In case of a malfunctioning positioning sensor 196, a bumper 198 is provided that is attached to the guide rails 186, the bumper 198 providing a physical means for stopping the retraction of the reference slide 178 at an end point, and thereby preventing the occurrence of physical damage to the reference slide 178.

Generally, to calibrate the apparatus 2, the reference slide 178 is inserted into the lowermost portion of the image viewing area opening 50 to allow for the balancing of the intensity and evenness of light that emanates from the two spotlights 162 and 164. To initiate the calibration step, a user inputs into the apparatus 2 information pertinent to the type of objects that are to be analysed so that an appropriate object classification program may be selected for the data analysis to be performed by the mini-PC 80. After the information is entered into the apparatus 2, the grey colour section 182 of the reference slide 178 is inserted into the lowermost portion of the image viewing area opening 50. Detection of the insertion of the grey colour section 182 occurs when the vertical member 188 is situated over a positioning sensor 190. Positioning of the vertical member 188 over the positioning sensor 190 causes the induction of the radiation device 86 and an image is captured by the image capturing device 48 upon illumination of the grey colour section 182 by the spotlights 162 and 164. At this stage, the mean grey intensity value is calculated and the voltage applied to the LED's is adjusted to bring the mean grey intensity value to a pre-determined target value, and to balance the intensity of the light between the two spotlights 162 and 164.

After the intensity and balancing adjustments are performed, the white balance settings of the image capturing device 48 are adjusted to equalize the mean red, green and blue intensity values. Thereafter, a second image of the grey colour section 182 is captured and a flat-field correction value is calculated to compensate for any unevenness in lighting and vignetting effects. The second captured image is then blurred to minimize an effect that any airborne particulate matter may have on a captured image, and a scale factor value calculated for each picture element in the captured image, the scale factor to be subsequently applied as a multiplier to each picture element in a captured image to ensure that the picture element intensity equals the mean intensity value for the captured image. On completion of these calibration calculations, the grey colour section 182 of the reference slide 178 is retracted from the image viewing area opening 50.

The retracting of the grey colour section 182 from the image viewing area opening 50 allows the colour chart section 180 to be positioned in the image viewing area opening 50. An image is captured of each sub-section of the colour chart section 180 when the vertical member 188 is positioned over each intermediate position sensor 192 and 194. When the two images are captured of the colour chart section 180, a correction factor is applied to the captured images based upon a set of pre-determined coefficients. The correction factor is based upon a calculation of the average red, blue and green values of the different colour squares when compared to a set of pre-programmed target values. If a calculated value is outside of a tolerance range for a pre-programmed target value, a colour correction coefficient is calculated based upon the measured value and the target value. Generally, calculation of the colour correction coefficient occurs when the apparatus 2 is utilized in a high or low temperature environment, or when the spotlights 162 and 164 are subject to a relatively high number of on/off cycles.

On completion of any calculation of the colour correction coefficient, the colour chart section 180 of the reference slide 178 is fully retracted from the image viewing area opening 50, and the apparatus 2 is ready to receive a batch sample of objects for analysis. The calculated flat-field and colour correction coefficients are applied to each image captured by the image capturing device 48 during the batch sample analysis. It is estimated that completion of the calibration procedure for the apparatus 2 takes in the range of about 5 to 20 seconds, while faster calibration time speeds of the ranges of about 5 to 15, and of about 5 to 10 seconds may be accomplished.

Operation of the Apparatus

Once the apparatus 2 is calibrated, the metering belt 64 and imaging conveyor belt 72 are set into rotating motion. The rotational speed of the imaging conveyor belt 72 is fixed at a particular speed for the type of objects to be analysed, for example, a particular grain commodity. The speed of the imaging conveyor belt 72 is also, in part, affected by an image capture and processing rate of the camera 46. The positioning of the metering plate 116 is adjusted by the operator so that the objects to be analyzed will not be damaged or crushed when exiting the metered bottom opening 112 of the hopper 42. A batch sample of the flowable objects to be analysed, usually grain or seeds, is deposited into the inlet 30 of the operating object analysis apparatus 2 and flow into the hopper 42.

Objects deposited into the hopper 42 flow out of the hopper 43 via the metered bottom opening 112 wherein the objects become frictionally-engaged by the textured surface provided by the teeth 106 on the surface of the rotating metering belt 64. The metering plate 116 provided within the hopper 42 possesses an angled portion 118 that diverts the objects so as to create an eddying effect upon the objects within the hopper 42 in the vicinity of the metered bottom opening 112, thereby causing the re-circulation back into the batch sample of objects within the hopper 42 of those objects that are not frictionally-engaged by the teeth 106 on the metering belt 64 at a given instance of time, thus maintaining the free flow of objects from the metered bottom opening 112 of the hopper 42 onto the metering belt 64.

Objects that become frictionally-engaged by the metering belt 64 begin to exit from the metering belt housing 44 through the object exit area 124 and are deposited onto successive object presentation areas 138 of the rotating imaging conveyor belt 72. The rotational speed of the metering belt 64 is set to co-ordinate with the speed of the imaging conveyor belt 72. The positioning of the metering plate 116 is adjusted so that the frictionally-engaged objects are deposited onto the at least one object presentation area 138 of the imaging conveyor belt 72 in a monolayer and at a desired density for presentation to the image capturing device 48.

In the usual course of operation, there is the continuous deposition of objects from the metering belt 64 into a continuous series of congruous object presentation areas 138 on the imaging conveyor belt 72. The resulting effect is that there is a uninterrupted series of discrete object presentation areas 138 bearing a monolayer of discrete objects being presented to the field of view of image capturing device 48. Successful operation of the object analysis apparatus 2 is not reliant on the discrete objects being presented in an orderly arrangement within the field of view of the image capturing device 48. Image data is collected with respect to every discrete object within the given object presentation area 138, and the image data is only collected when the object presentation area 138 is within the field of view of the image capturing device 48. At the instant when the given object presentation area 138 is correctly aligned within the field of view of the image capturing device 48, the operation of the image capturing device 48 is triggered along with the operation of the radiation device 86 for exposure of the objects within the object presentation area 138 to the desired wavelength of radiation.

The simultaneous triggering of the image capturing device 48 and the radiation device 86 together with the continuous presentation of the object monolayer-bearing object presentation areas 138 to the image capturing device 48 is accomplished due to the cooperation between the triggering device 144 that is associated with each object presentation area 138 and sensor 148 for both the radiation device 86 and the image capturing device 48. Once the objects are exposed and the image is captured, the object presentation area 138 exits the filed of view of the image capturing device 48 and the objects are subsequently deposited from the imaging conveyor belt 72 into receptacle 34 for subsequent removal from the object analysis apparatus 2. Access in the object analysis apparatus 2 is provided for the removal of the receptacle 34 as well as for servicing individual components of the apparatus 2. Alternatively, the imaged objects may be deposited from the imaging conveyor belt 72 onto a downstream conveyor that allows for the imaged particles to be thereafter deposited into discrete containers or packages for future use or storage.

During operation of the apparatus 2, the possibility of cross-contamination between objects from different batch samples is abated due to the combined effects of one or more factors such as the presence of the tab 58 that dissipates static electricity that may build-up on the apparatus 2. Other factors include the provision of the brush 154 for the continuous cleaning of the imaging conveyor belt, the elimination of crevasses or small gaps between components of the apparatus, the rails 132 and the runners 134 and 136, the sloped configuration of the cleats 142 on the imaging conveyor belt 72, the close proximity of the metering belt 64 to the imaging conveyor belt 72 so as to reduce the probability of objects bouncing off of the imaging conveyor belt 72 upon their landing on the imaging conveyor belt 72, and by ensuring that any internal surface of the hopper 42 and hopper extension 74 possesses a vertically-orientated milling pattern.

Batch Sample Analysis Example

A batch sample of 6437 seeds of Canadian Western Red Spring wheat were deposited into the operating apparatus. Analysis of the batch sample, minus approximately 2% of the seeds being rejected from the analysis due to seed clumping, occurred over an elapsed time of approximately sixty-six seconds, plus approximately fifteen seconds to complete the apparatus calibration step. Processing of the batch sample required the capturing of one hundred and sixty-five separate images at an image capture rate of 2.5 images per second, with an average of approximately thirty-nine seeds per object presentation area 138 being analysed. Based on this example, a throughput rate for the apparatus 2 is in a range of approximately five thousand to six thousand seeds per minute. It will be recognised by those of skill in the art that the throughput rate for the apparatus 2 will vary depending upon the size of the objects deposited into the apparatus 2. In the present example, successful colour differentiation (Medium Red Spring wheat versus Light Red Spring wheat) was accomplished at an accuracy rate of greater than ninety-nine per cent.

All parameters expressed herein may be combined in any desired and suitable manner to create additional combinations or embodiments of the invention and such combinations are all within the scope of the invention disclosed herein.

1. An apparatus for analyzing batch samples of flowable objects comprising:
an object feeder having a metered bottom opening which opens onto a metering belt, the metered bottom opening being adjustable in accordance with the object size;
the metering belt having a textured upper surface to engage frictionally the objects flowing from the feeder;
a conveyor located below and close to the metering belt, the conveyor having at least one object presentation area for containing the objects, and having a triggering device associated therewith for a radiation device and a data capturing means;
wherein when a sample of objects is placed in the object feeder for analysis, the metered bottom opening is adjustable to provide a free flow of objects onto the metering belt and hence onto the conveyor for imaging and wherein the adjustment of the metered bottom opening is coordinated with the speeds of the metering belt and the conveyor such that a monolayer of objects of the sample to be analyzed is arranged in at least one object presentation area and as the area moves towards the radiation device and the data capturing means, the associated triggering device sets off the radiation device and data capturing means to enable the gathering of data for analysis.

2. An apparatus as claimed in claim 1, wherein the object feeder is a hopper, the hopper is provided with a positionally-adjustable metering plate within the hopper, the position of the metering plate being adjusted in accordance with the object size.

3. An apparatus as claimed in claim 1, wherein the data capturing means is selected from the group comprising a digital camera, an analog camera, an infrared detector, an acoustical detector, a laser detector, and an ultraviolet radiation detector.

4. An apparatus as claimed in claim 1, wherein the apparatus includes a receptacle for receiving objects that have been subject to a data capturing event, the receptacle being selected from the group comprising a bin, a sealable container, a conveyor and a weigh scale.

5. An apparatus as claimed in claim 1, wherein the data capturing means is connected to a computer programmed for storing and analyzing the captured data.

6. An apparatus as claimed in claim 5, wherein the apparatus is constructed in a modular format, wherein at least one module is provided for containing the computer for storing and analyzing the captured data.

7. An apparatus as claimed in claim 6, wherein the apparatus is portable.

8. An apparatus as claimed in claim 1, wherein the at least one object presentation area on the conveyor is defined by a plurality of equally-spaced parallel transverse projections located on a conveyor belt; the conveyor belt having a covering on its top and sides for containing the objects, and defining the other sides of the at least one object presentation area, the covering having an opening which permits unobstructed irradiation and data capture of the objects within the at least one object presentation area.

9. An apparatus as claimed in claim 8, the apparatus comprising continuous cleaning means for removing objects and particulate material from the conveyor belt after a data capturing event.

10. An apparatus as claimed in claim 9, wherein the cleaning means is a brush.

11. An apparatus as claimed in claim 8, wherein the conveyor belt has a colour that provides a neutral background and a high contrast with the objects to be analyzed.

12. An apparatus as claimed in claim 11, wherein the circumference of the opening is coated with a material that reflects the radiation emanating from the radiation device into the object presentation area.

13. An apparatus as claimed in claim 12, wherein the radiation device comprises panels of light emitting diodes.

14. An apparatus as claimed in claim 13, wherein the light emitting diodes operate stroboscopically.

15. An apparatus as claimed in claim 14, wherein the apparatus is provided with a means to calibrate the apparatus prior to the analysis of the batch sample.

16. An apparatus as claimed in claim 15, wherein the means to calibrate the apparatus is provided by a reference slide, the reference slide being inserted into the conveyor so as to be presented to the radiation device and the data capturing means.

17. An apparatus as claimed in claim 16, wherein the reference slide consists of at least two sections, the at least two sections consisting of a colour reference chart section and a grey colour section.

18. An apparatus as claimed in claim 1, wherein the radiation device and the data capturing means are situated within a positive air pressure environment within the apparatus.

19. A method for preparing a batch sample of flowable objects for presentation to a radiation device and a data capturing means, the method comprising the steps of:
(a) obtaining a batch sample of the flowable objects to be analyzed, and
(b) depositing the flowable objects into an object analysis apparatus, the apparatus comprising:
an object feeder having a metered bottom opening which opens onto a metering belt, wherein the metered bottom opening is adjustable in accordance with the object size;
the metering belt having a textured upper surface to engage frictionally the objects flowing from the feeder;
a conveyor located below and close to the metering belt, the conveyor having at least one object presentation area for containing the objects, and having a triggering device associated therewith for a radiation device and a data capturing means;
wherein when a sample of objects is placed in the object feeder for analysis, the metered bottom opening is adjustable to provide a free flow of objects onto the metering belt and hence onto the conveyor for imaging, and wherein the metered bottom opening is coordinated with the speeds of the metering belt and the conveyor such that a monolayer of objects of the sample to be analyzed is arranged in at least one object presentation area and as the area moves towards the radiation device and the data capturing means, the associated triggering device sets off the radiation device and data capturing means to enable the gathering of data for analysis.

20. A method as claimed in claim 19, wherein prior to the deposition of the flowable objects into the apparatus, a calibration process is performed, the calibration process comprising the steps of:
insertion of a reference slide into an image viewing area opening located in the conveyor;
capturing an image of a grey colour reference section of the reference slide;
calculating a flat-field correction co-efficient to be applied to an image captured of the monolayer of objects arranged in the at least one object presentation area when the associated triggering device sets off the radiation device and data capturing means;
capturing at least one image of an at least one colour chart section of the reference slide;
calculating a colour correction co-efficient that is to be applied to the image captured of the monolayer of objects; and
withdrawing the reference slide from the image viewing area opening.
